(19) United States
(12) Patent Application Publication
(10) Pub. No.: US 2022/0094760 A1
(43) Pub. Date: Mar. 24, 2022

(54) APPARATUS AND METHOD FOR GENERATING PROXY FOR DOCKERIZED ARTIFICIAL INTELLIGENCE LIBRARY AND ROS DISTRIBUTED SYSTEM BASED ON DOCKERIZED ARTIFICIAL INTELLIGENCE LIBRARY

(71) Applicant: Electronics and Telecommunications Research Institute, Daejeon (KR)

(72) Inventors: Choul-Soo JANG, Daejeon (KR); Byoung-Youl SONG, Daejeon (KR)

(73) Assignee: Electronics and Telecommunications Research Institute, Daejeon (KR)

(21) Appl. No.: 17/318,880

(22) Filed: May 12, 2021

(30) Foreign Application Priority Data
Sep. 23, 2020 (KR) 10-2020-0122809

(51) Int. Cl. H04L 29/08; H04L 29/06; G06F 8/61

(52) U.S. Cl. CPC H04L 67/288; H04L 67/2809; G06F 8/63; H04L 67/40; H04L 67/2814

(57) ABSTRACT

Disclosed herein are an apparatus and method for generating a proxy for a Dockerized AI library. The method may include generating a proxy server and a proxy client for relaying access to an AI library based on an interface predefined for the access to the AI library generated as a Docker image according to an embodiment, generating a Dockerfile in order to generate a new Docker image configured to run the AI library in the form of a server using the generated proxy server, and generating the new Docker image based on the Dockerfile.

### CROSS REFERENCE TO RELATED APPLICATION

This application claims the benefit of Korean Patent Application No. 10-2020-0122809, filed Sep. 23, 2020, which is hereby incorporated by reference in its entirety into this application.

### BACKGROUND OF THE INVENTION

### 1. Technical Field

The disclosed embodiment relates to technology for a robot capable of providing service by fusing various artificial-intelligence (AI) modules.

### 2. Description of the Related Art

Robots provide service to users by fusing various AI modules that perform voice recognition, natural language processing, object recognition, user recognition, behavior recognition, appearance characteristic recognition, location recognition, travel route generation, joint trajectory generation, manipulation information generation, and the like using voice information, image information, and various kinds of sensor information.

The performance of state-of-the-art AI modules is greatly improving with the advancement of machine learning based on an Artificial Neural Network (ANN), and an increasing number of AI modules based on a neural network is being launched.

When an AI algorithm is developed, AI modules based on a neural network need various AI frameworks, such as TensorFlow, Caffe, PyTorch, Keras, and the like, and various external packages required for the AI algorithm. That is, in order to run neural-network-based AI modules that are dependent on various AI frameworks and external packages, it is necessary to install the corresponding frameworks and packages on which the algorithms depend in an Operating System (OS).

However, it is difficult to simultaneously run two or more AI modules on a single OS because the AI modules may require different versions of AI frameworks and external packages or because the libraries required for the external packages may conflict with each other, that is, a dependency conflict may occur.

In order to solve this problem, Python language uses virtualenv, which is capable of creating an isolated virtual environment for each program, thereby solving the problem of dependency conflicts between Python packages that are downloaded from PyPI (the Python Package Index, http://pypi.org) and installed. However, virtualenv is usable only for Python packages, and virtual environments for other system libraries required by an OS cannot be provided thereby. Also, a system integrator who develops a robot service has to take full responsibility for installing packages and system libraries, which are the dependencies of a specific AI module, in the virtual environment of the corresponding module in order to run the AI module, and this may be a demanding task.

In order to solve this problem, container technology, which is configured to create an image that includes all of an OS, runtime and system libraries, external packages, and the like required for executing software therein and to run the same using a Docker, has been recently developed, but so far it is used mainly for applications based on web servers.

Meanwhile, with regard to robots, a robot service is configured by creating a distributed application system using a distributed framework called a ‘Robot Operating System (ROS)’ as a method for fusing multiple modules.

However, developers who develop AI library modules generally have expertise in developing general-purpose AI algorithms but lack knowledge about distributed frameworks specific to robots, such as a ROS, so it is difficult for the developers to create a Docker image by creating a ROS node using the developed AI library modules. Conversely, because system integrators who configure ROS nodes and thereby develop a robot system in an integrated manner lack knowledge about AI modules and a Docker environment, they have difficulty in creating a Docker image by combining required AI modules with a ROS framework.

That is, although an AI library module having good performance has been newly developed, it is not easy to integrate the AI library module into a system due to a dependency conflict with an existing module. Also, even though the AI library module is virtualized and provided as a Docker image, a system integration developer who is unaccustomed to the Docker environment may not use the AI library module, having good performance.

### DOCUMENTS OF RELATED ART

### (Patent Document 1) Korean Patent No. 10-2125260.

### SUMMARY OF THE INVENTION

An object of the disclosed embodiment is to enable a Dockerized AI library, developed by a developer who lacks knowledge about a distributed framework, to be used in a robot system by being integrated into the robot system.

Another object of the disclosed embodiment is to enable developers who lack knowledge about AI libraries and a Docker environment to develop a robot distributed system based on services provided by various AI library modules in a distributed node environment.

A method for generating a proxy for a Dockerized AI library according to an embodiment may include generating a proxy server and a proxy client for relaying access to an AI library based on an interface predefined for access to an AI library generated as a Docker image; generating a Dockerfile in order to generate a new Docker image configured to run the AI library in the form of a server using the generated proxy server; and generating the new Docker image based on the Dockerfile.

Here, the interface may be defined using an Interface Definition Language (IDL) such that the proxy client calls the AI library through Remote Procedure Call (RPC) communication and such that the proxy server returns a result of processing a request from the proxy client using the AI library to the proxy client in response to the request.

Here, the RPC communication may be one of multiple RPC communication mechanisms including a ROS service and gRPC or XML-RPC.

Here, the Docker image may be generated in such a way that files required for an environment for running the AI library are layered and stacked.

Here, when the Docker image is formed of N stacked Docker layers, the proxy server may be stacked as an (N+1)-th Docker layer.

Here, in the Dockerfile, the name of a folder in which proxy server code and code for running the proxy server are saved may be copied.

Here, in the Dockerfile, ENTRYPOINT, which is set so as to start the proxy server when the new Docker image is executed, may be specified.

Here, the proxy client may be installed in a Robot Operating System (ROS) node and provide an AI service to the ROS node by calling the AI library through the proxy server.

An embodiment is an apparatus for generating a proxy for a Dockerized AI library, the apparatus including memory in which at least one program is recorded and a processor for executing the program. The program may perform generating a proxy server and a proxy client for relaying access to an AI library based on an interface predefined for access to an AI library generated as a Docker image; generating a Dockerfile in order to generate a new Docker image configured to run the AI library in the form of a server using the generated proxy server; and generating the new Docker image based on the Dockerfile.

Here, the interface may be defined using an Interface Definition Language (IDL) such that the proxy client calls the AI library through Remote Procedure Call (RPC) communication and such that the proxy server returns a result of processing a request from the proxy client using the AI library to the proxy client in response to the request.

Here, the RPC communication may be one of multiple RPC communication mechanisms including a ROS service and gRPC or XML-RPC.

Here, the Docker image may be generated in such a way that files required for an environment for running the AI library are layered and stacked.

Here, when the Docker image is formed of N stacked Docker layers, the proxy server may be stacked as an (N+1)-th Docker layer.

Here, in the Dockerfile, the name of a folder in which proxy server code and code for running the proxy server are saved may be copied.

Here, in the Dockerfile, ENTRYPOINT, which is set so as to start the proxy server when the new Docker image is executed, may be specified.

A ROS distributed system based on a Dockerized AI library according to an embodiment includes multiple Robot Operating System (ROS) nodes communicating with counterpart ROS nodes retrieved from a ROS core. AI library proxy clients may be installed in the respective ROS nodes, an AI library proxy server and a Docker image generated as the AI library may be executed in a Docker container, the AI library proxy clients may call the AI library through Remote Procedure Call (RPC) communication, and the AI library proxy server may return a result of processing a request from the AI library proxy client using the AI library to the AI library proxy client in response to the request.

Here, the RPC communication may be one of multiple RPC communication mechanisms including a ROS service and gRPC or XML-RPC.

Here, one of the AI library proxy clients and another one of the AI library proxy clients may call the AI library proxy server using different RPC communication mechanisms.

Here, the ROS distributed system may further include an additional ROS node that is executed in a Docker container along with an AI library, and the AI library proxy client may be installed in a ROS node and communicate with another AI library proxy client installed in another ROS node or with the additional ROS node implemented in the Docker container through publish/subscribe (pub/sub) messaging.

Here, the ROS nodes and the Docker container may be executed in different respective hosts.

### BRIEF DESCRIPTION OF THE DRAWINGS

The above and other objects, features and advantages of the present invention will be more clearly understood from the following detailed description taken in conjunction with the accompanying drawings, in which.

FIG. 1 is a schematic block diagram of a distributed system using a ROS to which an embodiment is applied;

FIG. 2 is a schematic block diagram of a distributed environment formed using a Dockerized AI library and a ROS;

FIGS. 3 to 5 are views for explaining a method for generating a proxy for a Dockerized AI library according to an embodiment;

FIG. 6 is an exemplary view of a Docker image;

FIG. 7 is an exemplary view of a new Docker image;

FIG. 8 is an exemplary view of an IDL file written for an RPC-based interface with an AI library;

FIG. 9 is an exemplary view of an IDL file written for an RPC-based interface with an AI library;

FIG. 10 is an exemplary view of code for running a proxy server according to an embodiment;

FIG. 11 is an exemplary view of a Dockerfile according to an embodiment;

FIG. 12 is a view illustrating an embodiment of the configuration of a distributed environment using a Dockerized AI library and a ROS:

FIG. 13 is a view illustrating another embodiment of the configuration of a distributed environment using a Dockerized AI library and a ROS;

FIG. 14 is a view illustrating a further embodiment of the configuration of a distributed environment using a Dockerized AI library and a ROS; and

FIG. 15 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

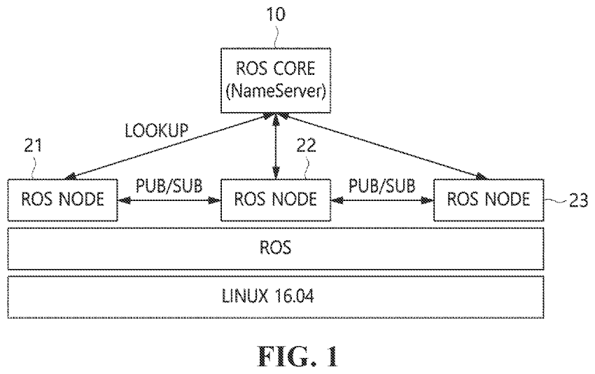

Hereinafter, an apparatus and method for generating a proxy for a Dockerized AI library and a ROS distributed system based on the Dockerized AI library according to an embodiment will be described in detail with reference to FIGS. 1 to 15.

With regard to robots, a robot service is configured by creating a distributed application system using a distributed framework called a Robot Operating System (ROS) as a method of fusing different modules.

FIG. 1 is a schematic block diagram of a distributed system using a ROS to which an embodiment is applied.

Referring to FIG. 1, the distributed system using a ROS is configured such that multiple ROS nodes 21, 22 and 23 constituting a distributed application operate as individual processes on an Operating System (OS) and communicate with other ROS nodes mainly through publish/subscribe (pub/sub) messaging.

The ROS nodes 21, 22 and 23 look up the counterpart ROS nodes with which to communicate by accessing a ROS core 10, which is a kind of name server, and establish the distributed system by communicating with the counterpart ROS nodes.

When the ROS nodes 21, 22 and 23 in the distributed system environment intend to use different AI library modules, the respective ROS nodes 21, 22 and 23 have to be run in different individual virtual environments.

Accordingly, each of the AI libraries is modularized using a Docker, which is a kind of virtual machine and is a means for resolving dependence between libraries, and the modularized AI library is incorporated in a distributed processing environment, whereby service for robots may be configured.

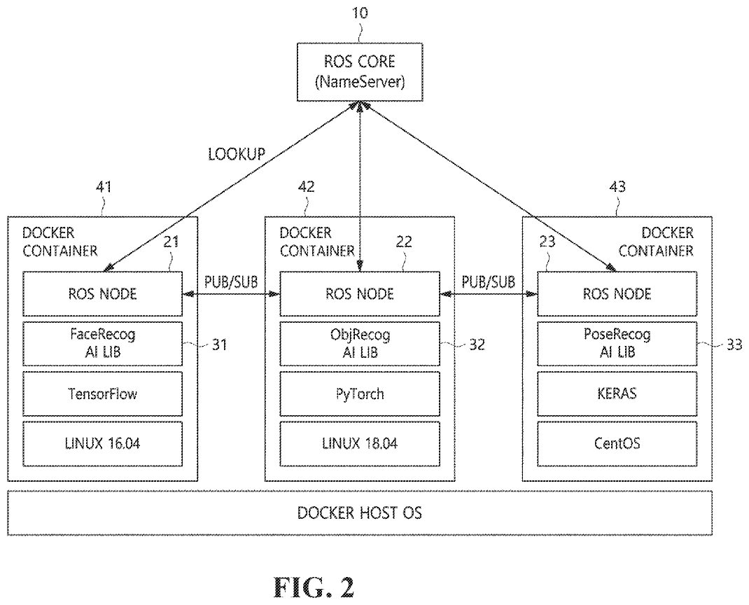

FIG. 2 is a schematic block diagram of a distributed environment formed using a Dockerized AI library and a ROS.

Referring to FIG. 2, a distributed environment formed using Dockerized AI libraries and ROS nodes may be implemented such that the ROS nodes 21, 22 and 23 are created as respective Docker images along with corresponding ones of AI libraries 31, and 33 and are run in Docker containers 41, 42 and 43 corresponding thereto.

However, developers who develop AI library modules generally have expertise in developing a general-purpose AI algorithm but lack knowledge about distributed frameworks specific for robots, such as a ROS, as described above. Therefore, it is not easy for the developers to form a ROS node and create a Docker image using the developed AI library modules. On the other hand, because system integrators who form ROS nodes and thereby develop a robot system in an integrated manner lack knowledge about AI modules and a Docker environment, they have difficulty in creating a Docker image by combining required AI modules with a ROS framework. That is, it is not easy to configure the distributed environment illustrated in FIG. 2.

An embodiment proposes technology in which an AI library is created as a Docker image in the form of a server and a ROS node functioning as a client is enabled to use the AI library of the Docker image in the form of a server, whereby developers who develop Dockerized AI library modules are able to develop algorithms by installing only a required package and AI framework without the need to consider dependencies of other packages and various AI frameworks and are able to provide a library service by being provided with an independent execution environment in the Docker container.

That is, the embodiment provides an apparatus and method for generating a proxy running between a ROS node and a Dockerized AI library in order to facilitate the configuration of a distributed environment using the Dockerized AI library and a ROS. Hereinafter, an embodiment in which a distributed environment of a robot system is configured is described in order to explain the apparatus and method for generating a proxy for a Dockerized AI library, but the present invention is not limited thereto. That is, the present invention may also be applied when a different kind of distributed system, other than a robot system, is formed.

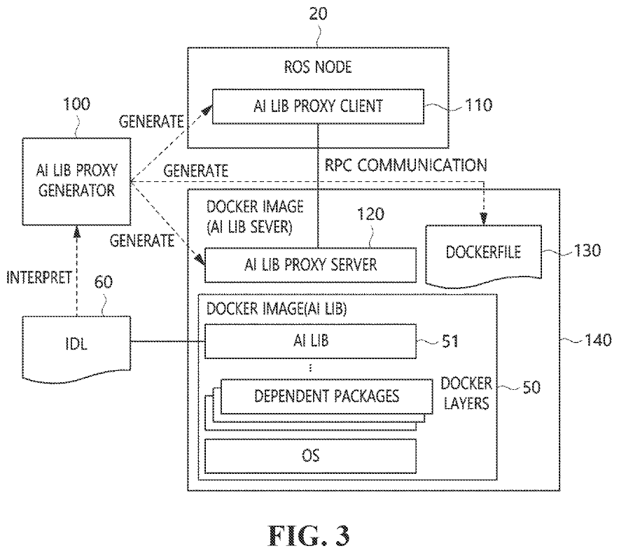

FIGS. 3 to 5 are views for explaining a method for generating a proxy for a Dockerized AI library according to an embodiment.

Referring to FIG. 3, according to an embodiment, an AI library proxy client (AI Lib Proxy Client, referred to as a ‘proxy client’ hereinbelow) 110 may be installed in a ROS node 20, and an AI library proxy server (AI Lib Proxy Server, referred to as a ‘proxy server’ hereinbelow) 120 and a Docker image 50, including an AI library 51, may be created as a new Docker image 140 and run in a Docker container (not illustrated).

That is, the proxy client 110 and the proxy server 120 may be implemented so as to liaise between the ROS node 20 and the AI library 51. Accordingly, developers developing the ROS node 20 and the AI library 51 may enjoy increased freedom.

A method of generating a new Docker image 140, which is implemented such that the proxy server 120 and the AI library 51 are run in the form of a server in order to provide a proxy function, will be described in detail below.

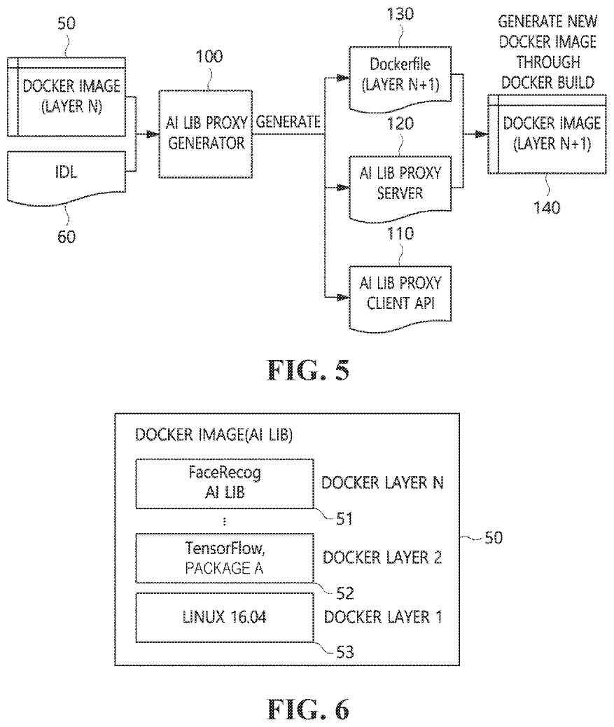

Here, the method for generating a proxy for a Dockerized AI library according to an embodiment may be performed by the AI library proxy generator (AI Lib Proxy Generator, referred to as a ‘proxy generator’ hereinbelow) 100, illustrated in FIG. 3 and FIG. 5.

Referring to FIGS. 3 to 5, the method for generating a proxy for a Dockerized AI library may include generating a proxy client 110 and a proxy server 120 for relaying access to an AI library at step S210 based on an interface 60 that is predefined for access to the AI library 51 generated as a Docker image 50, generating a Dockerfile 130 for generating a new Docker image 140 configured to run the AI library in the form of a server using the generated proxy server 120 at step S220, and generating the new Docker image 140 in the form of a server using the Dockerfile 130 at step S230.

Here, the Docker image 50 may be generated in such a way that files required for an environment for running the AI library are layered and stacked. That is, in order to configure the environment for running the developed AI library, AI library module developers may generate a Docker image by sequentially stacking files required for the corresponding library using the layering technique of a Docker.

FIG. 6 is an exemplary view of a Docker image.

Referring to FIG. 6, a Docker image 50 may be generated in such a way that a face recognition AI library (FaceRecog AI Lib) 51 forms a Docker layer N and that files 52 and 53 required for the face recognition AI library (FaceRecog AI Lib) 51 are stacked as underlying Docker layers (Docker layers 1 to N−1). The files required for the AI-based face recognition library (FaceRecog), e.g., Linux 16.04 53 and TensorFlow 52, are sequentially stacked as Docker layers, whereby a Docker image 50 may be generated.

Here, a new Docker image 140 may perform a server function for the AI library 51.

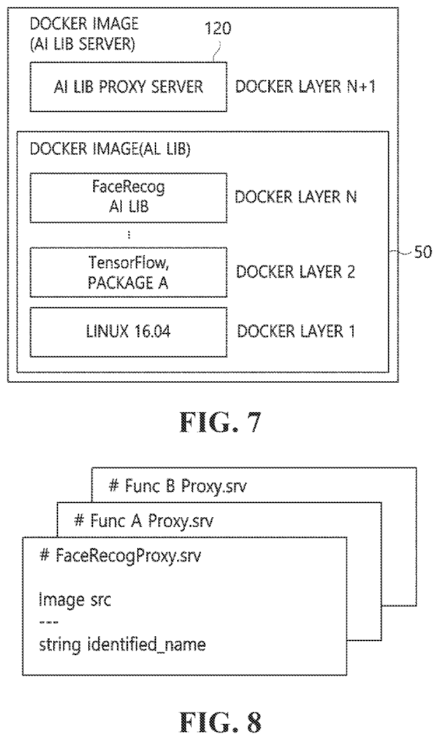

FIG. 7 is an exemplary view of a new Docker image.

As shown in FIG. 7, a new Docker image 140 may be generated by adding a proxy server 120 as a Docker layer N+1 in the existing Docker image 50.

Meanwhile, in order to perform step S210, an interface has to be predefined in order to access the AI library generated as a Docker image.

Here, the interface may be defined using an Interface Definition Language (IDL) such that a proxy client calls an AI library through Remote Procedure Call (RPC) communication and such that a proxy server returns the result of processing a request from the proxy client using the AI library to the proxy client in response to the request. That is, developers have to define the interface using the IDL in order to access the AI library generated as a Docker image.

Accordingly, the proxy generator 100 automatically generates a proxy client 110 and a proxy server 120, which are client code and server code, based on the IDL at step S210.

Here, the method of RPC communication between the proxy client 10 and the proxy server 120 may be implemented using ROS service communication or various RPC mechanisms that can create code written in a programming language from the IDL, such as gRPC. XML-RPC, and the like, and the language is not limited.

FIG. 8 is an exemplary view of an IDL file written for an RPC-based interface with an AI library.

For example, when an RPC based on a ROS service is used, the srv file (FaceRecogProxy.srv) shown in FIG. 8 may be defined as an IDL file for an AI library (FaceRecog) configured to perform face recognition for an input image source (Image src) and to return the name of a recognized user (string identified_name).

Here, the respective functions to be called may be defined as individual IDL files, and the IDL files may be processed as an interface package. That is, referring to FIG. 8. FaceRecogProxy.srv, FuncAProxy.srv, and FuncBProxy.srv are defined as IDL files, and may be processed as an interface package.

Here, the AI library proxy server (AI Lib Proxy Server) is configured to receive an execution request from a proxy client, to process the request using the AI library, and to return the result thereof.

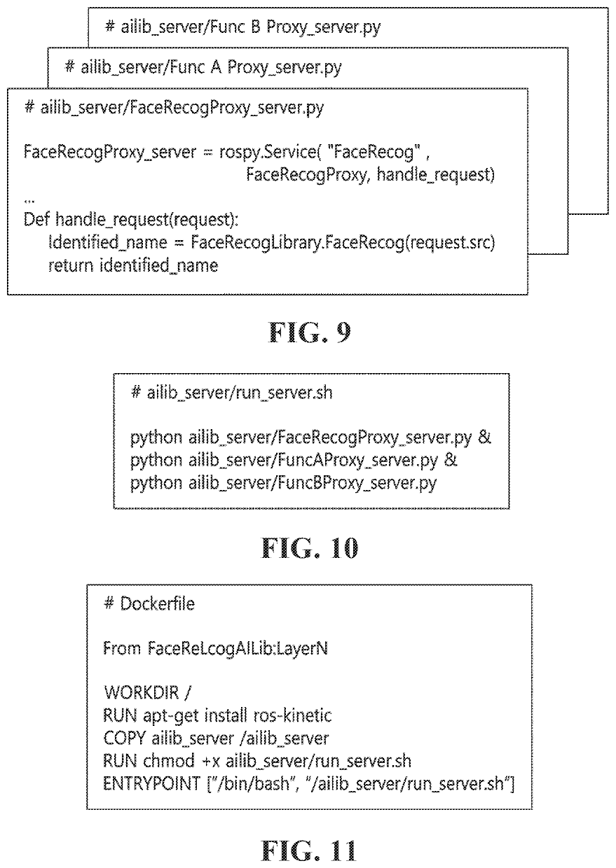

FIG. 9 is an exemplary view of an IDL file written for an RPC-based interface with an AI library.

For example, referring to FIG. 9, code for the AI library proxy server for face recognition (FaceRecogProxy_server) is written to include a part (rospy.Service( . . . )) for preparing for reception of an execution request from a proxy client and a part for returning the name of a recognized user (identified_name) using a face recognition function of a face recognition AI library (FaceRecogLibrary.FaceRecog) in response to the execution request.

Here, when an interface package defined using multiple IDL files is used, proxy servers may be generated for the respective functions.

Meanwhile, in the Dockerfile 130, a command for copying the name of a folder in which the proxy server code and the code for running the proxy server are saved, and ENTRYPOINT, which is set so as to start the proxy server at the time of running the new Docker image, may be specified.

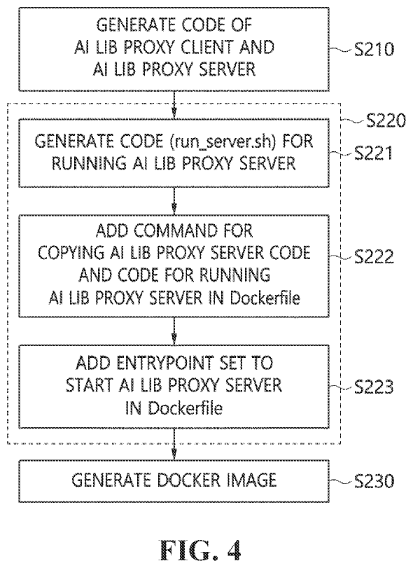

To this end, step S220 may include generating code for running the proxy server at step S231, adding a command for copying the proxy server code and the code for running the proxy server in the Dockerfile at step S232, and specifying a command for starting the proxy server using ENTRYPOINT in the Dockerfile at step S233, as shown in FIG. 4.

FIG. 10 is an exemplary view of code for running a proxy server according to an embodiment.

Referring to FIG. 10, when the generated AI library Docker container is executed, a shell script (run_server.sh) for running the proxy server is generated.

Here, all of the generated proxy server and necessary files may be saved in a specific folder (e.g., an ailib_server folder).

FIG. 11 is an exemplary view of a Dockerfile according to an embodiment.

The Dockerfile is written so as to install basic packages required for RPC communication. For example, when a Remote Procedure Call (RPC) based on a ROS service is used, a ROS package is additionally installed in a Docker image (apt-get install ros-kinetic), as shown in FIG. 11.

Also, in the Dockerfile, a command for copying a folder (ailib_server), in which code for interfacing with a proxy server and shell script code (run_server.sh) for running the proxy server are saved, to a new Docker image and ENTRYPOINT, which is set so as to start the server when the Docker to be newly generated is started, are specified.

Meanwhile, when a Docker image is generated through a command-line interface for Docker (docker build) using the Dockerfile generated at step S230, a new Docker image capable of starting the AI library in the form of a server may be generated.

As described above, because the AI library proxy client (AI Lib Proxy Client), which is client code for RPC request/response, is generated by the proxy generator 100, distributed-node developers only need to implement a part for calling the library using the AI library proxy client (AI Lib Proxy Client) when they write logic of the corresponding node.

That is, the distributed-node developers may develop an integrated system in the same form as if they established a distributed environment based on inter-process communication in their host OS. That is, the ROS node may be developed using the already generated AI proxy client code without consideration as to whether the generated AI library is provided based on Docker or a system library provided by the host OS itself.

The AI library proxy client (AI Lib Proxy Client) implemented in the ROS node accesses the AI library proxy server (AI Lib Proxy Server) running as a server and calls the library through an RPC request/response mechanism, whereby AI service may be provided to the ROS node.

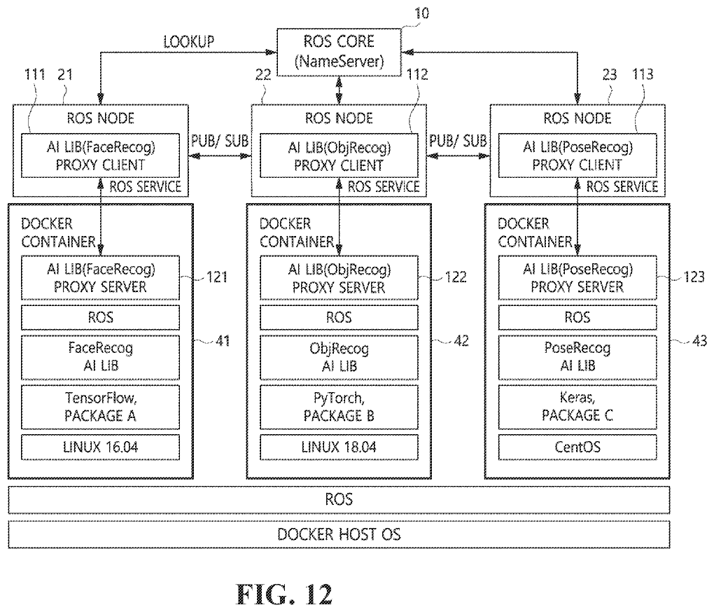

FIG. 12 is a view illustrating an embodiment of the configuration of a distributed environment using a Dockerized AI library and a ROS.

FIG. 12 shows an example in which, when an AI library for face recognition (FaceRecog), an AI library for object recognition (ObjRecog), and an AI library for user behavior recognition (PoseRecog) are used, distributed ROS nodes are generated and operated using Docker containers 41, 42 and 43, which are run using Docker images including AI proxy servers (AI Lib Proxy Server) 121, 122 and 123 generated according to an embodiment, and AI proxy clients (AI Lib Proxy Client) 111, 112 and 113 when various operating systems, packages dependent thereon, and AI frameworks are present.

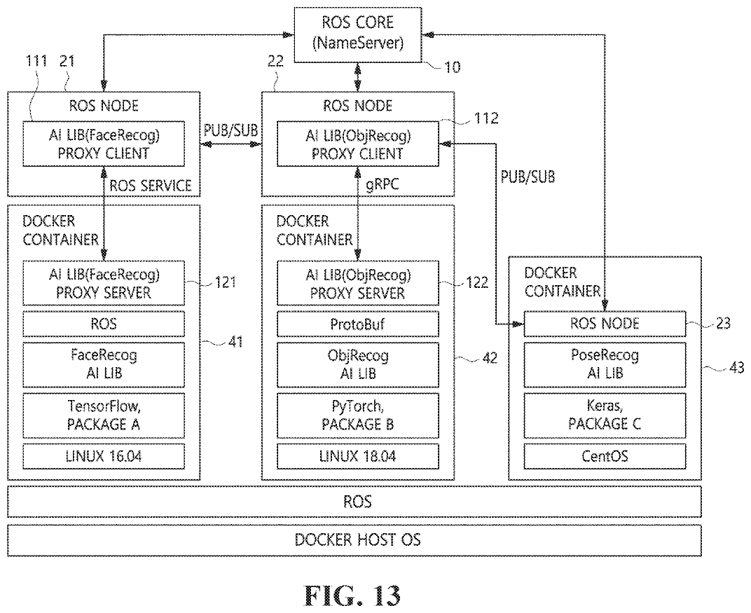

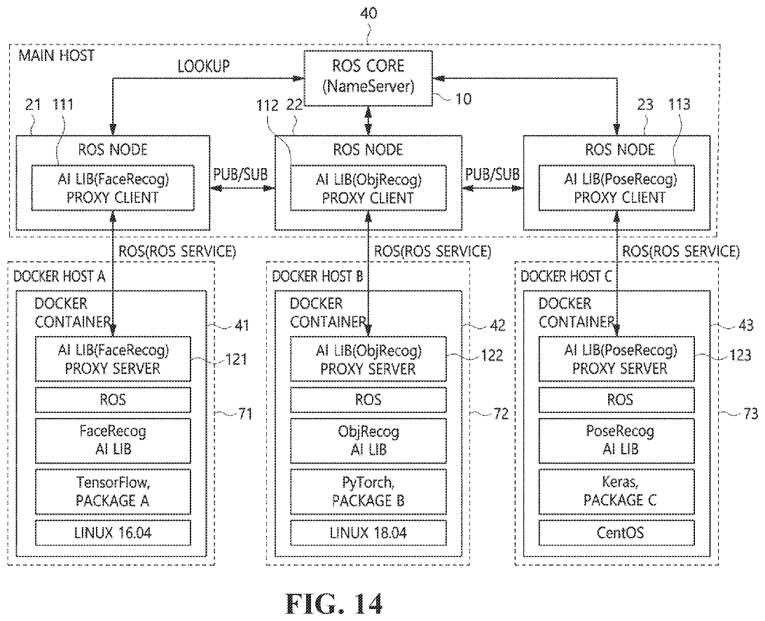

FIG. 13 is a view illustrating another embodiment of the configuration of a distributed environment using a Dockerized AI library and a ROS.

FIG. 13 shows an example in which ROS nodes (FaceRecog and ObjRecog) and 22 that use Docker-based AI libraries generated according to an embodiment coexist with a Docker container (PoseRecog) that includes both an AI library and a ROS node 23 according to a conventional method and in which communication through publish/subscribe (pub/sub) messaging based on a ROS is performed therebetween.

Here, the proxy client 111 of the ROS node 21, which is generated according to an embodiment, may be implemented to use RPC communication based on a ROS service when it calls the AI library for recognizing a face (FaceRecog), but the proxy client 112 of the other ROS node 22, which is generated according to an embodiment, may be implemented to use RPC communication of gRPC using ProtoBuf when it calls the AI library for recognizing an object (ObjRecog).

FIG. 14 is a view illustrating a further embodiment of the configuration of a distributed environment using a Dockerized AI library and a ROS.

Referring to FIG. 14, it can be seen that Dockerized AI library modules may be run in Docker hosts separate from ROS nodes. The Docker hosts that run the AI library modules may be general PCs or a virtual operating environment provided in a cloud.

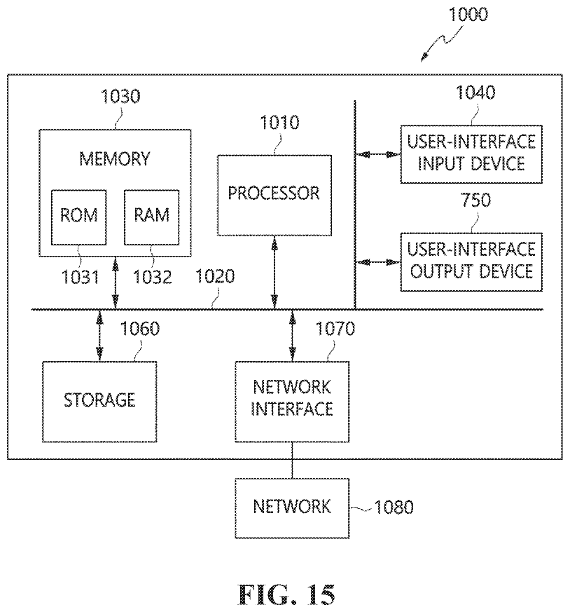

FIG. 15 is a view illustrating a computer system configuration according to an embodiment.

The apparatus for generating a proxy for a Dockerized AI library according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, AI library module developers are able to develop algorithms by installing only a required package and AI framework without the need to consider dependencies of other packages and various AI frameworks, and are able to provide a library service by being provided with an independent execution environment in a Docker container.

Also, developers who try to develop a distributed node using a created AI library may develop the distributed node in the same form as if they established a distributed environment based on inter-process communication on a local host OS, regardless of whether the AI library is a library installed in their host OS or a library installed in a Dockerized guest OS, whereby there is an effect in which various AI library modules may be easily integrated into a distributed system while allowing coexistence thereof without dependency problems.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for generating a proxy for a Dockerized AI library, comprising:
generating a proxy server and a proxy client for relaying access to an AI library based on an interface predefined for access to an AI library generated as a Docker image;
generating a Dockerfile in order to generate a new Docker image configured to run the AI library in a form of a server using the generated proxy server; and
generating the new Docker image based on the Dockerfile.

2. The method of claim 1, wherein the interface is defined using an Interface Definition Language (IDL) such that the proxy client calls the AI library through Remote Procedure Call (RPC) communication and such that the proxy server returns a result of processing a request from the proxy client using the AI library to the proxy client in response to the request.

3. The method of claim 2, wherein the RPC communication is one of multiple RPC communication mechanisms including a ROS service and gRPC or XML-RPC.

4. The method of claim 1, wherein the Docker image is generated in such a way that files required for an environment for running the AI library are layered and stacked.

5. The method of claim 4, wherein, when the Docker image is formed of N stacked Docker layers, the proxy server is stacked as an (N+1)-th Docker layer.

6. The method of claim 1, wherein, in the Dockerfile, a command for copying a name of a folder in which proxy server code and code for running the proxy server are saved is saved.

7. The method of claim 4, wherein, in the Dockerfile, ENTRYPOINT, which is set so as to start the proxy server when the new Docker image is executed, is specified.

8. The method of claim 1, wherein the proxy client is installed in a Robot Operating System (ROS) node and provides an AI service to the ROS node by calling the AI library through the proxy server.

9. An apparatus for generating a proxy for a Dockerized AI library, comprising:
memory in which at least one program is recorded, and
a processor for executing the program,
wherein the program performs
generating a proxy server and a proxy client for relaying access to an AI library based on an interface predefined for access to an AI library generated as a Docker image;
generating a Dockerfile in order to generate a new Docker image configured to run the AI library in a form of a server using the generated proxy server; and
generating the new Docker image based on the Dockerfile.

10. The apparatus of claim 9, wherein the interface is defined using an Interface Definition Language (IDL) such that the proxy client calls the AI library through Remote Procedure Call (RPC) communication and such that the proxy server returns a result of processing a request from the proxy client using the AI library to the proxy client in response to the request.

11. The apparatus of claim 10, wherein the RPC communication is one of multiple RPC communication mechanisms including a ROS service and gRPC or XML-RPC.

12. The apparatus of claim 9, wherein the Docker image is generated in such a way that files required for an environment for running the AI library are layered and stacked.

13. The apparatus of claim 12, wherein, when the Docker image is formed of N stacked Docker layers, the proxy server is stacked as an (N+1)-th Docker layer.

14. The apparatus of claim 9, wherein, in the Dockerfile, a command for copying a name of a folder in which proxy server code and code for running the proxy server are saved is saved.

15. The apparatus of claim 12, wherein, in the Dockerfile, ENTRYPOINT, which is set so as to start the proxy server when the new Docker image is executed, is specified.

16. A ROS distributed system based on a Dockerized AI library, comprising:
multiple Robot Operating System (ROS) nodes communicating with counterpart ROS nodes retrieved from a ROS core,
wherein:
AI library proxy clients are installed in the respective ROS nodes,
an AI library proxy server and a Docker image generated as the AI library are executed in a Docker container,
the AI library proxy clients call the AI library through Remote Procedure Call (RPC) communication, and
the AI library proxy server returns a result of processing a request from the AI library proxy client using the AI library to the AI library proxy client in response to the request.

17. The ROS distributed system of claim 16, wherein the RPC communication is one of multiple RPC communication mechanisms including a ROS service and gRPC or XML-RPC.

18. The ROS distributed system of claim 17, wherein one of the AI library proxy clients and another one of the AI library proxy clients call the AI library proxy server using different RPC communication mechanisms.

19. The ROS distributed system of claim 18, further comprising:
an additional ROS node that is executed in a Docker container along with an AI library,
wherein:
the AI library proxy client is installed in a ROS node and communicates with another AI library proxy client installed in another ROS node or with the additional ROS node implemented in the Docker container through publish/subscribe (pub/sub) messaging.

20. The ROS distributed system of claim 16, wherein the ROS nodes and the Docker container are executed in different respective hosts.
